(19) United States
(12) Patent Application Publication
(10) Pub. No.: US 2025/0170808 A1
(43) Pub. Date: May 29, 2025

(54) PANELS FOR FORMWORK AND RELATED DEVICES, SYSTEMS, AND METHODS

(71) Applicant: Wilian Holding Co., Des Moines, IA (US)

(72) Inventors: Andrew Gray, Ankeny, IA (US); Daniel L. Ashby, Lorimor, IA (US)

(73) Assignee: Wilian Holding Co., Des Moines, IA (US)

(21) Appl. No.: 18/960,787

(22) Filed: Nov. 26, 2024

Related U.S. Application Data
(60) Provisional application No. 63/603,851, filed on Nov. 29, 2023.

(51) Int. Cl. B32B 27/12; B32B 27/32

(52) U.S. Cl. CPC B32B 27/12; B32B 27/32; B32B 2250/05; B32B 2250/242; B32B 2262/101; B32B 2305/024; B32B 2305/08; B32B 2305/10; B32B 2307/72; B32B 2323/10; B32B 2419/00

(57) ABSTRACT

A facing panel comprising a first polymer sheet, a second polymer sheet, and a honeycomb core between the first polymer sheet and the second polymer sheet. A method for forming a facing panel comprising feeding a first polymer sheet, a second polymer sheet, and a honeycomb core through a double belt press, wherein the honeycomb core is thermally bonded between the first polymer sheet and the second polymer sheet.

### CROSS-REFERENCE TO RELATED APPLICATION(S)

This application claims the benefit under 35 U.S.C. § 119(e) to U.S. Provisional Application 63/603,851, filed Nov. 29, 2023, and entitled Panels for Formwork and Related Devices, Systems, and Methods, which is hereby incorporated herein by reference in its entirety for all purposes.

### TECHNICAL FIELD

This disclosure relates to facing/panels for use with formwork, particularly formwork for concrete.

### BACKGROUND

Various materials have been utilized commercially for formwork facing. Aluminum and steel faced formwork panels are utilized often in welded formwork. As would be appreciated, steel offers durability, strength, economy, flexibility, and resistance to bending. However, steel is heavy, irreplaceable in the assembly, rusts over time, and is incompatible with many fasteners. Aluminum provides a lighter option that is easier to fasten to but is less durable and weaker than steel. Additionally, aluminum reacts with cement paste, creating hydrogen and tenacious bond between the materials.

A second type of formwork, framed formwork, was introduced, partially, to provide a formwork panel with a replaceable face sheet. This framed formwork is often marketed with a plywood product as the forming face. Plywood facing materials are replaceable, sustainable, and economical. Plywood facing is compatible with all or nearly all fasteners, and provides superior stiffness compared with steel or aluminum face panels. Yet, plywood suffers from water intrusion, is easily damaged, and has a short product life cycle due to its lack of durability.

A vast majority of framed formwork panels are faced with some variation of a plywood product, among those being phenolic film faced plywood, polypropylene skinned plywood, fiber reinforced facing, plyforms, Baltic birch panels, and HDO (“High Density Overlay”) plywood.

To address some of the shortcomings these known products possess fully composite plastic facings have been marketed as direct replacements for plywood product facing. These composite plastic products are often comprised of a layer of solid facing plastic with a load carrying layer directly underneath, followed by a foamed plastic core structure. While these composite plastic products have improved durability, are easier to repair, and mitigate problems with water intrusion, when compared to plywood product they are typically heavier and significantly more expensive than the plywood products.

### BRIEF SUMMARY

In Example 1, a facing panel comprising a first uni-directional continuous fiber reinforced sheet, a second uni-directional continuous fiber reinforced sheet, and a honeycomb core between the first polymer sheet and the second polymer sheet, wherein the first uni-directional continuous fiber reinforced sheet and second uni-directional continuous fiber reinforced sheet run in along a length of the facing panel.

Example 2 relates to the facing panel of any of Examples 1 and 3-14, configured for use with concrete formwork.

Example 3 relates to the facing panel of any of Examples 1-2 and 4-14, wherein the first uni-directional continuous fiber reinforced sheet and second uni-directional continuous fiber reinforced sheet are comprised of continuous glass fiber reinforced thermoplastic.

Example 4 relates to the facing panel of any of Examples 1-3 and 5-14, where the first uni-directional continuous fiber reinforced sheet and second uni-directional continuous fiber reinforced sheet are comprised of 0/90 cross laying continuous glass fiber reinforced polypropylene.

Example 5 relates to the facing panel of any of Examples 1-4 and 6-14, wherein the first uni-directional continuous fiber reinforced sheet and second uni-directional continuous fiber reinforced sheet are thermally bonded to the honeycomb core.

Example 6 relates to the facing panel of any of Examples 1-5 and 7-14, further comprising a first film layer on the first uni-directional continuous fiber reinforced sheet and a second film layer on the second uni-directional continuous fiber reinforced sheet, the first film layer and second film layer on outer surfaces of the facing panel.

Example 7 relates to the facing panel of any of Examples 1-6 and 8-14, wherein the first film layer and the second film layer are unreinforced polypropylene.

Example 8 relates to the facing panel of any of Examples 1-7 and 9-14, wherein the first uni-directional continuous fiber reinforced sheet and second uni-directional continuous fiber reinforced sheet each comprise a 0/90 cross laying continuous fiber film sheet and a continuous glass fiber reinforced thermoplastic.

Example 9 relates to the facing panel of any of Examples 1-8 and 10-14, wherein the honeycomb core is an about ø6 mm 160-240 kg/m3 polypropylene honeycomb core.

Example 10 relates to the facing panel of any of Examples 1-9 and 11-14, wherein the honeycomb core is an about ø6 mm 180 kg/m3 polypropylene honeycomb core.

Example 11 relates to the facing panel of any of Examples 1-10 and 12-14, wherein the first uni-directional continuous fiber reinforced sheet and second uni-directional continuous fiber reinforced sheet are bonded to the honeycomb core via adhesive.

Example 12 relates to the facing panel of any of Examples 1-11 and 13-14, wherein the facing panel is recyclable.

Example 13 relates to the facing panel of any of Examples 1-12 and 14, wherein the facing panel is water tolerant.

Example 14 relates to the facing panel of any of Examples 1-13, wherein the facing panel is repairable.

In Example 15, a concrete formwork facing panel, comprising a first film layer, a first fiber reinforced sheet bonded to the first film layer, a honeycomb core bonded to the first fiber reinforced sheet, second fiber reinforced sheet bonded to the honeycomb core, and a second film layer bonded to the second fiber reinforced sheet.

Example 16 relates to the concrete formwork facing panel of any of Examples 15 and 16-19, wherein the first fiber reinforced sheet and the second fiber reinforced sheet each comprise a uni-directional fiber reinforced polymer sheet and a 0/90 cross laying continuous fiber reinforced sheet.

Example 17 relates to the concrete formwork facing panel of any of Examples 15-16 and 17-19, wherein the first film layer and the second film layer each comprise UV stabilized polypropylene.

Example 18 relates to the concrete formwork facing panel of any of Examples 15-17 and 19, wherein the honeycomb core is an about ø6 mm 160-240 kg/m3 polypropylene honeycomb core.

Example 19 relates to the concrete formwork facing panel of any of Examples 15-18, wherein the first film layer and second film layer each comprise a 350 gsm UV stabilized polypropylene film and a 35 gsm spunbound non-woven PET fabric bonding layer; the first fiber reinforced sheet and the second fiber reinforced sheet each comprise a first 500 gsm unidirectional film sheet in a strong direction of a panel, an 800 gsm 0/90 cross laying continuous fiber film sheet, a second 370 gsm uni-directional film sheet in the strong direction of the panel, and a third 370 gsm uni-direction film sheet in the strong direction of the panel; and the honeycomb core comprises an about ø6 mm 180 kg/m3 polypropylene honeycomb core.

In Example 20, a method for forming a facing panel comprising feeding a first polymer sheet, a second polymer sheet, and a honeycomb core through a belt press, wherein the honeycomb core is thermally bonded between the first polymer sheet and the second polymer sheet.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an expanded view of a panel, according to one implementation.

FIG. 2 is a front view of the panel, according to one implementation.

FIG. 3 is a perspective view of a panel, according to one implementation.

FIG. 4 is a cross-sectional view of a panel, according to one implementation.

FIG. 5 is an expanded view of one specific configuration of a panel, according to one implementation.

FIG. 6 is an exemplary image of an unmolded concrete form made with a prior known facing panel.

### DETAILED DESCRIPTION

Disclosed herein is a composite panel for use with concrete formwork. In various implementations the panel includes a honeycomb core structure between polymer sheets. More specifically, the various panel implementations described herein utilize continuous glass fiber reinforced thermoplastic polymer sheets (CFRT) thermally bonded to a honeycomb core structure to produce an improved formwork facing material. The panels described herein are light weight, economical, durable, water tolerant, and repairable.

The disclosed panels provide extreme durability, including resistance to permanent deformations due to blunt impacts, surpassing the performance of steel. The various panel implementations may be easily nailed into and yet the resulting nail holes are inconsequential to the intrusion of water—an improvement over the plywood products. Further, the weight of the disclosed panels is approximately 30% lighter than a plywood facing of the same thickness. Still further, the cost of the disclosed panels is less than known composite plastic products. Additionally, the disclosed formwork panel is repairable using well established plastic welding methods, improving reusability compared to prior known products. Still further, the disclosed panels may be thermoformed into a variety of geometries and are not limited to flat sheets like plywood products.

Various implementations of the disclosed panels may be manufactured to match or nearly match the thicknesses of commonly utilized formply products, providing interchangeability with prior known facing materials and compatibility with readily available formwork systems. Various alternative implementations can be manufactured utilizing various thicknesses of facing and core materials, as would be understood. By matching or nearly matching common thicknesses of prior known panels the disclosed panels provide the required performance characteristics in a thickness of a facing material that is common to the class (strength) of formwork that has been designed, allowing for site substitution of facing materials or use in other forming applications.

Due to the nature of concrete construction, durability of the formwork facing is key in deriving value. The wear facings of the plywood-based products are very thin and cause short product lifecycles. The disclosed panels feature a facing material similar in thickness to known products with better durability.

As would be understood, production of many materials used for concrete construction facing are width limited and/or directional, that is having different bending properties in one axis versus another. Due to the flexibility of the production method disclosed herein, the disclosed panels can be produced continuously, and at a variety of widths, to reduce the amount of resulting scrap versus that of prior known alternative products. That is, the disclosed panels can be produced into desired shapes and sizes easily without excessive waste.

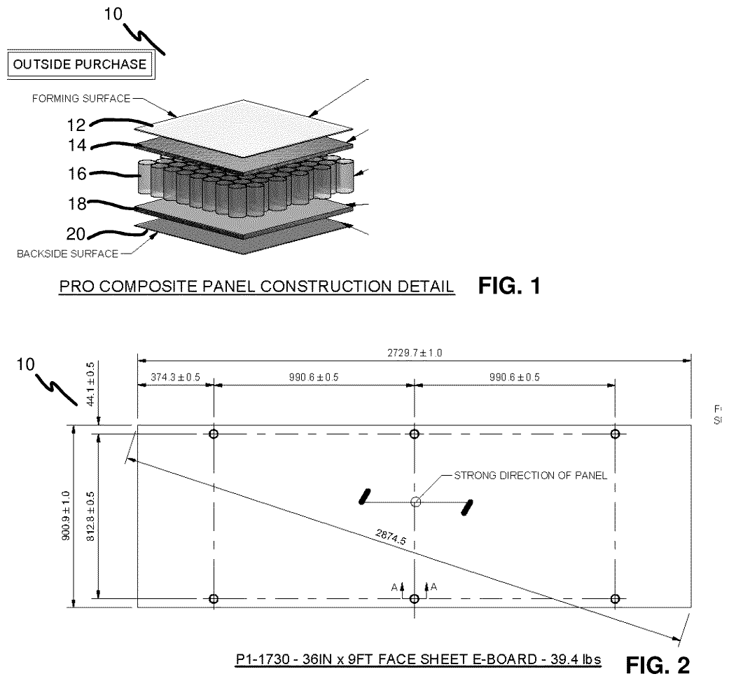

Turning to the figures in more detail, FIG. 1 shows an expanded view of a panel 10 section distinguishing the various layers of the panel 10. One layer of the panel 10 is a film layer 12 on the forming surface side of the panel, that is the side of the panel that will abut the poured concrete. In various implementations, the film layer 12 is an unreinforced polypropylene wear facing-a polypropylene film. The film layer 12 contacts the cast concrete and optionally provides a finish to the concrete surface while protecting further layers of the panel 10. In certain specific implementations, the film layer 12 is 350 gsm (grams per square meter) white polypropylene film. In further implementation, the film layer 12 may optionally be a 350 gsm ultra-violet (UV) stabilized polypropylene with a 35 gsm spunbond non-woven polyethylene terephthalate (PET) fabric bonding layer for bonding to adjacent panel 10 layers. Various alternative compositions of the film layer 12 are possible and would be understood by those of skill in the art.

Another layer of the panel 10 is the fiber-reinforced sheet 14, optionally a continuous glass fiber reinforced thermoplastic (CFRT) polymer sheet 14. In certain specific implementations, the fiber-reinforced sheet 14 is an 1800 gsm UV stabilized 0/90 cross laying fiber-reinforced polypropylene sheet. In certain specific implementations, the fiber-reinforced sheet 14 is optionally a 500 gsm uni-directional (UD) film sheet in the strong direction of the panel, with an 800 gsm 0/90 cross laying continuous fiber film sheet and a 500 gsm UD film sheet in the strong direction of the panel. In various implementations the uni-directional sheets are run in the same direction (the strong direction) to increase stiffness of the panel 10, while the optional 0/90 cross laying sheet provides strength in the opposite direction of bending.

In another layer, a honeycomb core 16 is provided. In certain specific implementations, the honeycomb core 16 is a ø6 mm 220 kg/m³ polypropylene honeycomb core. Optionally, the honeycomb core 16 is an about ø6 mm 160-240 kg/m³ polypropylene honeycomb core. Further, the honeycomb core 16 is optionally an about ø6 mm 180 kg/m³ polypropylene honeycomb core. In still further implementations, the honeycomb core 16 is an about ø6 mm 220 kg/m³ polypropylene honeycomb core. As would be understood the density and parameters of the honeycomb core 16 may be adjusted or varied for a particular application.

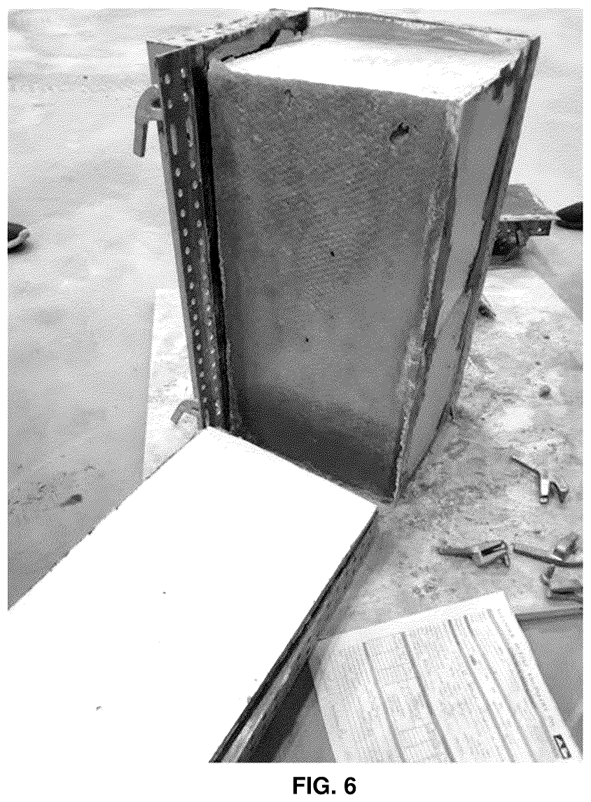

In various implementations, the core 16 density is increased over prior known products to minimize shear deformation. As would be understood, shear deformation results in localized facing deflection at the supporting panel members which can result in undesirable concrete finishes. FIG. 6 shows an example of a panel where the strength of the panel was not sufficient causing dimpling or other undesirable texturing in the concrete face.

Turning back to FIG. 1, the panel 10 also includes a further second/back fiber-reinforced sheet 18 and a second/back film layer 20. As would be appreciated the back fiber-reinforced sheet 18 may be similar to or the same as the front fiber-reinforced sheet 14 discussed above. In certain specific implementations, the back fiber-reinforced sheet 18 is a UV stabilized 0/90 cross laying fiber-reinforced polypropylene sheet. In certain specific implementations, the back fiber-reinforced sheet 18 is a UV stabilized 0/90 cross laying fiber-reinforced polypropylene sheet. In one specific implementation, the back film layer 20 includes a 350 gsm unreinforced Polypropylene sheet. Next to that, the back fiber-reinforced sheet 181 includes a 500 gsm UD film sheet in the strong direction of the panel, a 800 gsm 0/90 cross laying continuous fiber film sheet, and then a 370 gsm UD film sheet in the strong direction of the panel, and lastly a 370 gsm UD film sheet in the weak direction of the panel next to the core. In this specific implementation to back fiber-reinforced panel 18 and back film sheet 20 total 2390 gsm. Various alternative configurations, weights, and layers are possible and would be understood by those of skill in the art.

The back film layer 20 may be similar to or the same as the front film layer 12 discussed above. In certain specific implementations, the film layer 12 is 350 gsm off-white polypropylene film, optionally a 350 gsm UV stabilized polypropylene.

In various implementations the panel 10 has an asymmetrical layout, where the various layers are not of equal thickness providing stiffness to the panel 10. That is, the two fiber-reinforced sheet layers 14, 18 are not of the same thickness with the back fiber-reinforced sheet 18 being thicker. Also, the two film layers 12, 20 are not of the same thickness with the front film layer 12 being thicker. Various alternative configurations are possible and would be understood by those of skill in the art.

In certain implementations, the panel 10 is symmetrical. In symmetrical implementation, the fiber-reinforced sheets 14, 18 are of the same or similar thickness and the film layers 12, 20 are of the same or similar thickness. It would be appreciated that a symmetrical panel may allow for ease in manufacturing and usability with the panel being able to be faced in either direction.

As would be understood the various layers of the panel 10 are adhered together to form one panel 10. In various implementations, the panel 10 is formed on a double belt press machine. Various alternative machines and methods for adherence are possible and would be understood, certain of which are discussed further herein.

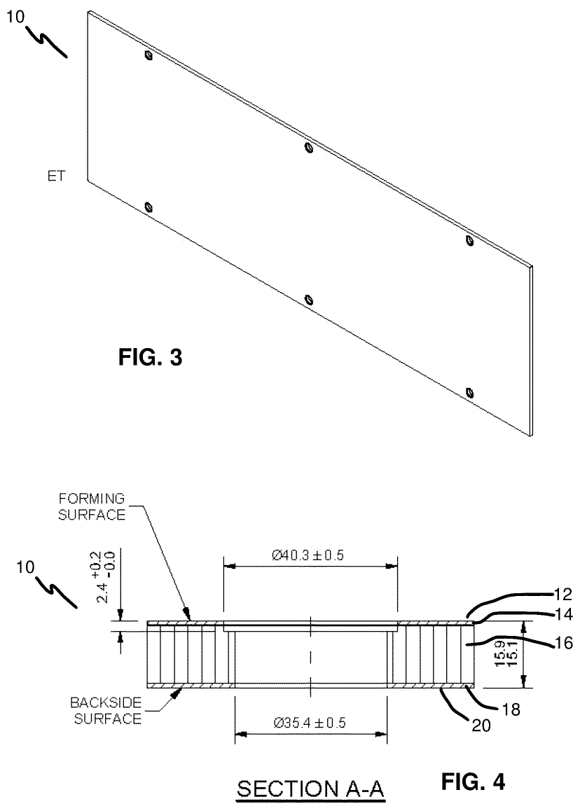

FIG. 2 shows a front elevation of the panel 10 indicating the strong direction of the panel 10. In these implementations the strong direction of the panel 10 is along the length of the panel. FIG. 3 shows a perspective view of the panel 10 and FIG. 4 shows a cross-section of the panel 10.

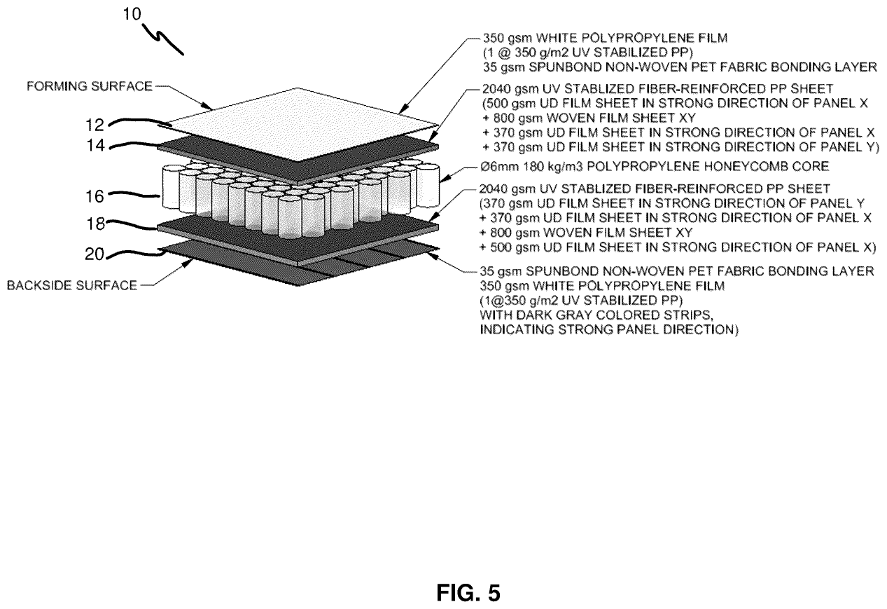

FIG. 5 shows one exemplary implementation of a symmetrical panel 10. The panel 10, in this specific implementation includes a first film layer 12 having a 350 gsm white polypropylene film and a 35 gsm spunbond non-woven PET fabric bonding layer. Adhered to the first film layer 12 is the first fiber reinforced sheet 14 having a 500 gsm UD film sheet in the strong direction of the panel, a 800 gsm 0/90 cross laying film sheet, a 370 gsm UD film sheet in the strong direction of the panel, and a 370 gsm UD film sheet in the strong direction of the panel. Adhered to the first fiber reinforced sheet 14 is the core 16. The core 16 being a a ø6 mm 180 kg/m³ polypropylene honeycomb core. Adhered to the core 16 is a back/second fiber reinforced sheet 18 having a 500 gsm UD film sheet in the strong direction of the panel, a 800 gsm 0/90 cross laying film sheet, a 370 gsm UD film sheet in the strong direction of the panel, and a 370 gsm UD film sheet in the strong direction of the panel. Adhered to the back/second fiber reinforced sheet 18 is a second/back film layer 20 having a 350 gsm white polypropylene film and a 35 gsm spunbond non-woven PET fabric bonding layer

The disclosed honeycomb composite panel 10 differs from prior known products in many ways discussed herein. The unreinforced polypropylene wear facing 12 on the contact surface between the cast concrete and the formwork face improves the concrete finish and protects the fiber reinforced layers 14 from being exposed to the concrete. The core density and cell size of the core 16 are configured to minimize distortions in the forming face resulting from heat in the production process. The layout of various layers provides improved panel stiffness and the layers are arranged to account for loading for use as a concrete formwork facing.

Still further, increased nail withdrawal capacity resulting from the arrangement of skin layers 12, 20, their thickness, and the density and cell size of the core 16 material provides an improved product. More specifically, the disclosed panel 10 improves upon nail withdrawal capacity over prior known composite panels by providing withdrawal forces and lateral resistance similar to plywood products without the water intrusion issues found in plywood products. Use of uni-directional continuous fiber reinforced (CFRT) sheets 14, 18 provides increased directional stiffness across supports while maintaining required stiffness and impact resistance in the opposing direction.

The disclosed panel 10 is an improvement over other plastic composite form facing products because it is lighter and less expensive.

The disclosed panel 10 is an improvement over film-faced plywood based products and other plywood-based facings including polypropylene skinned plywoods and film faced plywoods because it is significantly lighter and longer lasting than these products.

Additionally, the disclosed panel 10 is also an improvement over extruded PVC sheets (either laminated with a fiber reinforced sheet or not) that have generally been limited to use in horizontal applications due to insufficient stiffness which may cause distortions in the final product.

Lastly, the panels 10 disclosed herein are an improvement over molded plastic facing products due to the significant constraints of size and costs associated with a molded product.

Turning back to FIGS. 1-4, the disclosed panel is an arrangement of uni-directional continuous glass fiber reinforced polypropylene layers 14, 18 and a honeycomb core 20 to create a composite panel material specifically arranged for the design requirements necessary for performance in concrete formwork. The arrangement works by carrying bending stresses in the material in the outer (top and bottom) skin layers 12, 20. In these and other implementations, the materials responsible for carrying the majority of the stress and providing most of the stiffness in the design are the directional fiber reinforced polypropylene sheets 14, 18. An unreinforced polypropylene sheet 12 is utilized on the contacting face of the concrete.

The arrangement of the CFRT sheets 14, 18 on the top (front) and bottom (back) provide directional stiffness and strength to the resulting panel 10. Strength in the weak direction of the panel 10 is needed to provide resistance to damage from impact and stability to the panel 10 in the weak direction, this strength may be provided by a 0/90 cross laying layer/flim. In various implementations, the panel 10 may include a woven CFRT film as part of the CRFT sheets 14, 18 which may be laminated to the panel 10 continuously by use of a roll or other known method. This in contrast to a perpendicular installation of uni-directional CFRT film which must be hand placed in the opposite direction of the roll. Because perpendicular films must be prepared and placed by hand, there is a significant labor component as well as the potential for misplacement of the film strips. As would be understood, misplacement of a perpendicular uni-directional CFRT film may result in overlaps (and inconsistent thickness), gaps (and inconsistent properties), and misalignments. By using a 0/90 cross laying CFRT film as part of the CFRT sheets 14, 18, the film can be placed via continuous use of roll such that the amount of labor required to complete the panel 10 is reduced and consistency of the product is increased.

Due to the composition of the panel 10 structure, the core 16 arrangement allows for acceptable structural deformation performance as well as mitigates negative imprinting effects in the forming face 12 due to the production of the panel 10. As noted previously, insufficient strength can cause deformations, pillowing, dimpling, and other undesirable texturing in the finished concrete surface, shown for example in FIG. 5.

In various implementations, the panel 10 is a uni-directional fiber reinforced polypropylene honeycomb panel 10 made by bonding thermoplastic layers to a tubular core 16 structure thermally using a steel belt press or other similar device or mechanism. A steel belt press provides strength and smoothness to the finished panel 10. Other press types and arrangements are possible as would be understood.

In various additional and alternative implementations, the panel is from by adhesive bonding of the reinforce layers 14, 18 to a cellular or foamed core 16 structure. Various adhesive types and products are available and would be understood by those of skill in the art.

The various production processes allow for continuous production of the panel 10 at a predefined width. Upon production of a sheet of panels 10, individual panels 10 utilized in the formwork structure may then be cut to the desired size. Optionally, holes drilled are drilled, as shown in FIG. 3, via any known device such as a CNC cutting table. The final panel 10 may then be assembled into a formwork frame structure with bounding perimeter and intermediate support elements using countersunk blind rivets, as would be understood. Various alternative or additional finishing processes are possible and would be understood by those of skill in the art.

As has been discussed herein, the disclosed panel 10 provides numerous improvements over existing panels. Compared with existing form facing products, the disclosed panel 10 is more resistant to water and chemical damage, extremely durable, easily repairable, lighter weight, highly compatible with fasteners, and is cost competitive with phenolic film faced plywoods which are amongst the least expensive replaceable face sheet options.

Further, options exist for shaping the panel 10 material to suit, an option that does not easily exist for plywood-based products.

Additionally, being a thermoplastic product, the disclosed panel 10 may be recycled, improving environmental impacts of the panel 10.

The continuous production process results in a panels 10 that compete on raw cost directly with plywood where the longevity of use of the disclosed panels makes the lifetime cost of the product significantly more cost effective. Further, the disclosed panels 10 may be constructed of UV stable materials which allows for less costly outdoor storage options, an improvement over plywood products which are best stored under a roof to limit the exposure of the facing to water.

In various implementations, the panels 10 are comprised of directional fiber thermoplastic sheets that are bonded using heat to construct the composite structure. Other implementations could use thermoset plastics which must be bonded with adhesives.

Further, the panels 10 can be customized to provide the strength and stiffness sufficient for use in a thickness that is consistent with other facing products, giving the consumer more options to face their formwork frames that can be matched with the desires of the project (whether it be architectural, usage based, or availability based). Various panels 10 can be customized to have a thicker arrangement and, thus, may utilize thinner skins to carry the same load at the same stiffness.

Although the disclosure has been described with references to various embodiments, persons skilled in the art will recognize that changes may be made in form and detail without departing from the spirit and scope of this disclosure.

What is claimed is:

1. A facing panel comprising:
(a) a first uni-directional continuous fiber reinforced sheet;
(b) a second uni-directional continuous fiber reinforced sheet; and
(c) a honeycomb core between the first polymer sheet and the second polymer sheet,
wherein the first uni-directional continuous fiber reinforced sheet and second uni-directional continuous fiber reinforced sheet run in along a length of the facing panel.

2. The facing panel of claim 1, configured for use with concrete formwork.

3. The facing panel of claim 1, wherein the first uni-directional continuous fiber reinforced sheet and second uni-directional continuous fiber reinforced sheet are comprised of continuous glass fiber reinforced thermoplastic.

4. The facing panel of claim 3, where the first uni-directional continuous fiber reinforced sheet and second uni-directional continuous fiber reinforced sheet are comprised of 0/90 cross laying continuous glass fiber reinforced polypropylene.

5. The facing panel of claim 1, wherein the first uni-directional continuous fiber reinforced sheet and second uni-directional continuous fiber reinforced sheet are thermally bonded to the honeycomb core.

6. The facing panel of claim 1, further comprising a first film layer on the first uni-directional continuous fiber reinforced sheet and a second film layer on the second uni-directional continuous fiber reinforced sheet, the first film layer and second film layer on outer surfaces of the facing panel.

7. The facing panel of claim 8, wherein the first film layer and the second film layer are unreinforced polypropylene.

8. The facing panel of claim 1, wherein the first uni-directional continuous fiber reinforced sheet and second uni-directional continuous fiber reinforced sheet each comprise a 0/90 cross laying continuous fiber film sheet and a continuous glass fiber reinforced thermoplastic.

9. The facing panel of claim 1, wherein the honeycomb core is an about ø6 mm 160-240 kg/m³ polypropylene honeycomb core.

10. The facing panel of claim 1, wherein the honeycomb core is an about ø6 mm 180 kg/m³ polypropylene honeycomb core.

11. The facing panel of claim 1, wherein the first uni-directional continuous fiber reinforced sheet and second uni-directional continuous fiber reinforced sheet are bonded to the honeycomb core via adhesive.

12. The facing panel of claim 1, wherein the facing panel is recyclable.

13. The facing panel of claim 1, wherein the facing panel is water tolerant.

14. The facing panel of claim 1, wherein the facing panel is repairable.

15. A concrete formwork facing panel, comprising:
(a) a first film layer;
(b) a first fiber reinforced sheet bonded to the first film layer;
(c) a honeycomb core bonded to the first fiber reinforced sheet;
(d) a second fiber reinforced sheet bonded to the honeycomb core; and
(e) a second film layer bonded to the second fiber reinforced sheet.

16. The concrete formwork facing panel of claim 15, wherein the first fiber reinforced sheet and the second fiber reinforced sheet each comprise a uni-directional fiber reinforced polymer sheet and a 0/90 cross laying continuous fiber reinforced sheet.

17. The concrete formwork facing panel of claim 15, wherein the first film layer and the second film layer each comprise UV stabilized polypropylene.

18. The concrete formwork facing panel of claim 15, wherein the honeycomb core is an about ø6 mm 160-240 kg/m3 polypropylene honeycomb core.

19. The concrete formwork facing panel of claim 15, wherein the first film layer and second film layer each comprise a 350 gsm UV stabilized polypropylene film and a 35 gsm spunbound non-woven PET fabric bonding layer; the first fiber reinforced sheet and the second fiber reinforced sheet each comprise a first 500 gsm unidirectional film sheet in a strong direction of a panel, an 800 gsm 0/90 cross laying continuous fiber film sheet, a second 370 gsm uni-directional film sheet in the strong direction of the panel, and a third 370 gsm uni-direction film sheet in the strong direction of the panel; and the honeycomb core comprises an about ø6 mm 180 kg/m3 polypropylene honeycomb core.

20. A method for forming a facing panel comprising:
feeding a first polymer sheet, a second polymer sheet, and a honeycomb core through a belt press, wherein the honeycomb core is thermally bonded between the first polymer sheet and the second polymer sheet.
